(19) United States
(12) Patent Application Publication
(10) Pub. No.: US 2025/0121470 A1
(43) Pub. Date: Apr. 17, 2025

(54) METHOD FOR PERFORMING AN OPERATION ON AN ELONGATE, CURVED WORKPIECE AND A UNIVERSAL OPERATIONS CENTER OPERABLE FOR THE PRACTICE THEREOF

(71) Applicant: FAIRMOUNT TECHNOLOGIES, LLC, Wichita, KS (US)

(72) Inventors: Viswanathan MADHAVAN, Wichita, KS (US); Mahdi SAKET-KASHANI, Bel Aire, KS (US)

(73) Assignee: FAIRMOUNT TECHNOLOGIES, LLC, Wichita, KS (US)

(21) Appl. No.: 18/917,285

(22) Filed: Oct. 16, 2024

Related U.S. Application Data
(60) Provisional application No. 63/590,609, filed on Oct. 16, 2023.

(51) Int. Cl. B23Q 17/22

(52) U.S. Cl. CPC B23Q 17/22

(57) ABSTRACT

According to one or more embodiments, methods and systems for performing operations on a workpiece may be provided. An exemplary method may include holding the workpiece in a feeding fixture so that the workpiece is movable in one degree of freedom. The method may further include feeding the workpiece along the workpiece's length into an operations center and measuring the position of the workpiece in a length direction. A time sequence of processing vectors on the workpiece that are defined in a workpiece coordinate system may be transformed into a calculated time sequence of processing vectors in a machine coordinate system. Using a machine control system a processing end effector may be moved through the calculated time sequence of processing vectors in the machine coordinate system and one or more operations may be performed on the workpiece.

### BACKGROUND

Current CNC and universal operations machines require six rigid body degrees of freedom (DOFs) to be fixed in order to hold a workpiece in a fixed configuration with respect to the machine. These are commonly fixed using a 3-2-1 approach, with three supporting points locating a first plane of the workpiece against which a clamp acts to fix three DOFs-translation perpendicular to the surface and two rotations about vectors lying on the plane. Two other supports and a clamp pushing the part against them act on a second plane that is not parallel to the first and fixe two other DOFs-translation orthogonal to the first in the “normal” plane containing the normals to the first and the second planes, and a rotation about the normal to this plane. The final locator and a clamp acting against it in a direction that does not lie within the first and second planes remove translation along the clamping direction (the sixth and final DOF). In the tooling and fixturing art the 6 DOFs are sometimes thought of as a set of 12 DOFs, 6 each in the positive and negative directions along each DOF.

The 3-2-1 approach actually requires 6 supports/locators to locate the part by constraining one direction along each of the 6 DOFs and needs a minimum of three opposing clamps to constrain translations and rotations away from the locators. However, if the friction force acting on the supports is sufficient to constrain movement of the workpiece along its surface, the required number of locators and supports may be lesser. On the other hand, additional locators and clamps are required for curved flexible bodies to be held in their defined/required geometry to enable accurate location of operations and to prevent operation forces from changing the part geometry during operations such as machining, that apply significant localized forces to the workpiece. These fixtures require accurately machined surfaces into which the curved surface of the workpiece can nest and have many clamps distributed over the workpiece to locally resist processing forces, require significant engineering and manufacturing effort to produce, and drive the cost and schedule for curved parts machining. Programmable fixtures are used in complex, expensive, machines to hold curved parts for machining, but they require extensive effort to program for each part and do not support the part completely.

Elongate straight parts can be operated on by a variety of machines that feed the parts and move them through an operation zone containing the operating point. For a given location of the workpiece relative to the machine, the operation zone could include all or a subset of the points that the tool can access. These machines typically have long tables onto which the parts are clamped, or rollers that clamp onto the part and feed it relative to the tool. The location along the length coordinate is determined based on the incremental length of the workpiece fed through the machine, with respect to a feature defining the origin. Examples include CNC extrusion milling machines, tube lasers, punch presses, and roll forming machines. These vary the operations performed depending on the location of the processing point along the length of the straight workpiece being fed through the machine. Roll-feeder machines typically use roller fixtures to support straight parts around the operation zone while clamping the part to a rigid member of the machine to move it through the operation zone. This has the advantage that the processing area is clear of locators and clamps and permits processing to occur over the entire perimeter of the cross-section of the part. This can be used in cases where the part deflection under applied forces is negligible either due to the processing forces being small (e.g., tube lasers) or the workpiece being stiff compared to the unsupported length. This type of processing cannot be applied to curved parts because the motion of the part is controlled by an arm attached rigidly to a straight slide, etc. Additionally, the method of tracking the position of the workpiece via roller encoders is limited to situations where the part is straight and does not move or vibrate much due to processing forces.

There are relatively few machines that track the position of curved parts moving through an operation zone, however, these machines are not capable of tracking the length coordinate with the accuracy required for machining curved extrusions for use in airframe structures where the typical location tolerance of all features is +0.030″ even for parts as long as 20 feet, and performing other operations such as drilling, trimming, or thinning, over the cross-section of the workpiece. Currently, machines that move curved parts using rollers and track their position to process them do not claim high accuracy of positioning along the length coordinate, and only support quasi-static operations like bending that do not experience dynamic forces or vibrations experienced in a process like CNC milling.

Yet other machines perform operations at different locations along the curved cross-section of elongate workpieces such as aircraft and pipelines. The workpiece or the tool is moved relative to each other, and the movement is either continuous or an indexing motion for the machine to perform operations at different locations along the length. Either all of the coordinates are derived from the machine coordinate system, or purely from the workpiece. Any precise movements of the sort required for milling operations, such as precise back-and-forth relative motion with controlled position and speed as a function of time, are achieved by clamping rigid elements, whose motion is controlled by the machine, to these workpieces.

### SUMMARY

According to one or more embodiments methods and systems for performing operations on a workpiece may be provided. An exemplary method may include holding the workpiece in a feeding fixture so that the workpiece is movable in one degree of freedom along a length of the workpiece and constrained in all other degrees of freedom. The method may further include feeding the workpiece along the workpiece's length into an operations center and measuring the position of the workpiece in a length direction with respect to the feeding fixture using one or more sensors, where the measurement may be a cumulative distance of the workpiece past a known point and a zero position may be defined as the position of the workpiece when a known feature is at a known position. The orientation of the workpiece may be calculated with respect to the feeding fixture as a function of a workpiece position. A time sequence of processing vectors on the workpiece that are defined in a workpiece coordinate system may be transformed into a calculated time sequence of processing vectors in a machine coordinate system. Using a machine control system a processing end effector may be moved through the calculated time sequence of processing vectors in the machine coordinate system and one or more operations may be performed on the workpiece.

According to another embodiment a system for performing an operation on a workpiece may be provided. The system may include an operations center and a feeding fixture that holds the workpiece so that the workpiece is movable in one degree of freedom along a length of the workpiece but constrained in all other degrees of freedom, and feeds the workpiece along the length of the workpiece into the operations center. The system may further include one or more sensors that measure the position of the workpiece in a length direction, the measurement may be a cumulative distance of the workpiece past a known point and a zero position may be defined as the position of the workpiece when a known feature is at a known position. The system may further include a machine control system that moves a processing end effector through a calculated time sequence of processing vectors in a machine coordinate system. The operations center may calculate the orientation of the workpiece with respect to the feeding fixture as a function of a workpiece position and transform the time sequence of processing vectors on the workpiece that are defined in a workpiece coordinate system into a calculated time sequence of processing vectors in a machine coordinate system and may perform one or more operations on the workpiece.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1A shows an exemplary apparatus for performing one or more operations on a workpiece.

FIG. 1B shows an exemplary precision fixturing system showing a tool/spindle at a specific position and orientation with respect to the fixturing system.

FIG. 2 shows an exemplary precision feeding system.

FIG. 3A shows an exemplary system for positioning and orienting a tool/spindle at an operating point for the performance of an operation.

FIG. 3B shows another configuration of an exemplary system for positioning and orienting a tool/spindle at an operating point for the performance of an operation.

FIG. 4A shows an exemplary precision fixturing system.

FIG. 4B shows another view of an exemplary precision fixturing system.

FIG. 4C shows another configuration of an exemplary precision fixturing system.

FIG. 4D shows another view of an exemplary precision fixturing system.

FIG. 5 shows an exemplary workpiece feeding system with an independent tracking system.

FIG. 6 shows an exemplary embodiment of an apparatus providing increased precision in tracking the operation point on the workpiece.

FIG. 7 shows another exemplary embodiment of an apparatus.

FIG. 8A shows another view of an exemplary precision fixturing system with encoders within feed rollers according to an exemplary embodiment.

FIG. 8B shows another view of an exemplary precision fixturing system according to an exemplary embodiment.

FIG. 8C shows another view of an exemplary precision fixturing system according to an exemplary embodiment.

FIG. 9A shows the configuration of the encoder and roller on the rolling curve of a straight workpiece according to an exemplary embodiment.

FIG. 9B shows the configuration of the encoder and roller on the rolling curve of a variable curvature workpiece according to an exemplary embodiment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the embodiments described are not necessarily to be construed as preferred or advantageous over other embodiments. Moreover, the terms “embodiments of the invention”, “embodiments” or “invention” do not require that all embodiments of the invention include the discussed feature, advantage or mode of operation.

A computer numerically controlled (CNC) feeding-fixturing method and feeding fixture (FF) apparatus for locating and moving the operation point at which a tool engages a curved elongate workpiece for performing an operation may be provided. The curved workpiece may be an extrusion, roll formed section, brake formed section, sheet, and the like, with a cross-section that may be curved (swept or lofted) along a sweep curve to create the longitudinal direction (length dimension). One or more thickness dimensions defined along the cross-section may be much smaller than the longitudinal and transverse dimensions, while the sweep/loft of the transverse segments along the longitudinal direction may result in surfaces along which operations may be performed. Segmented or continuous curves may be defined on the surfaces (space curves). A time dependent traversal of a tool or sensor over a curve may be used to define an operation path or a tracking path, respectively. The term path may be understood to denote a curve with an additional time coordinate defining the time dependent motion of a point along the curve. Each path may be defined as a parametric space curve that evaluates to a unique point (position vector) on the curve for each value of the parameter time. It may also have an additional orientation vector corresponding to each point, with up to three additional functions of time that define the orientation vector, say, of a tool, when it is at that point.

According to one or more embodiments, methods and systems for performing operations on a workpiece may be provided. An exemplary method may include holding the workpiece in a FF so that it is movable in only one degree of freedom with respect to the FF, along a longitudinal direction of the workpiece, and is constrained in all other degrees of freedom. The method may further include feeding the workpiece along its longitudinal degree of freedom, a curvilinear coordinate named length, into an operations center and precisely controlling length as a function of time using one or more sensors, each of which may sense the movement of the workpiece past a sensing point on the FF, where the length coordinate may be a cumulative distance measured by the sensor from a known origin, the origin being defined as the length coordinate when the location of a known feature of the workpiece coincides with a known point on the FF. The orientation of the workpiece may be calculated with respect to the FF as a function of a workpiece position, and of time when the length is controlled as a function of time by the FF. A processing point defined in the workpiece coordinate system may need to be located along a certain operation plane of the operations center. The length coordinate required to achieve this may be calculated uniquely by a simulation of the kinematics of the workpiece moving through the FF. This length coordinate, and the two other coordinates of the processing point (along the operation plane) in the machine coordinate system together constitute the coordinates of the processing point in the machine coordinate system.

A processing operation to be carried out at a point on the workpiece may also need to be carried out with the processing tool at a defined orientation with respect to the workpiece, the point and the orientation being defined in a workpiece coordinate frame. A workpiece processing vector, a 6 DOF entity defined in the workpiece coordinate frame, which may include the processing point (3 DOF) and the tool orientation (3 DOF) for processing, may completely constrain the spatial relationship between the workpiece and the tool required for the processing operation to be successfully completed at that point. A time sequence of processing vectors may define a workpiece operation path. This may be transformed into a calculated machine operation path in a machine coordinate system using the known position and orientation of the workpiece with respect to the FF, as well as the known position and orientation of the FF with respect to the operations center at each time in the time sequence. Using a machine control system a processing end effector holding the tool may be interpolated through the machine operation path in the machine coordinate system in synchronization with the workpiece being moved through the time sequence of processing vectors by the FF, and one or more operations may be performed on the workpiece.

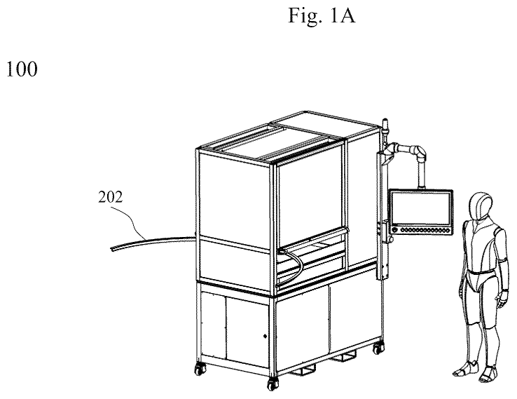

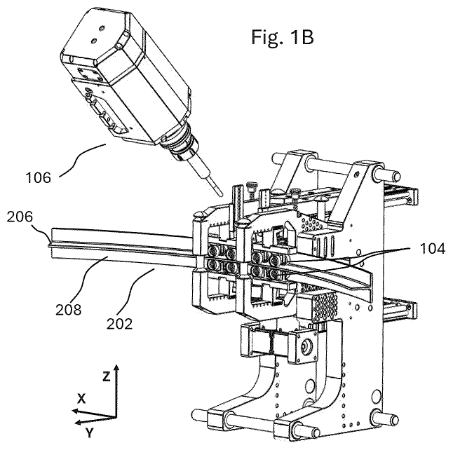

Referring to FIG. 1A, an apparatus 100 operable for the practice of the method described may be shown and described. The apparatus 100 may include, for example, a feeding means, a fixturing means for the workpiece, a precision positioning means for the spindle/tool, a chip removal system, and a length measuring device, which may be located at a known measuring point with respect to the fixturing means.

Referring to FIG. 1B, an embodiment of a universal feeding fixture (UFF) 101 comprising of a feeding means, a fixturing means for the workpiece, a precision positioning means for the workpiece 202 is shown. The coordinate system shown is the machine coordinate system along the operation plane that lies along the plane of symmetry of the UFF for the shown configuration. This figure shows the tool and the spindle 406 at a specific position and orientation with respect to the UFF. The degrees of freedom of the spindle may include translation along X, Y, and Z axes as well as rotation along an A axis parallel to the X-axis and about a B axis perpendicular to the tool axis in the operation plane. The UFF feeds the part along a curvilinear length coordinate that is approximately parallel to the X-axis, and may additionally have a rotary degree of freedom (A′-axis) along the X-axis that allows it to accommodate cross-sections where the vertical leg (flange) 208 is not perpendicular to the web (206). Simultaneous or tandem or sequential positioning and orienting of the tool along with positioning and orienting of the workpiece 202 using the universal feeding fixture 101 may allow relative movement of tool with respect to the workpiece in five degrees of freedom, to perform an operation, or to carry out a series of operations along an operation path, with linking moves in between different segments of the operation path to produce the desired part.

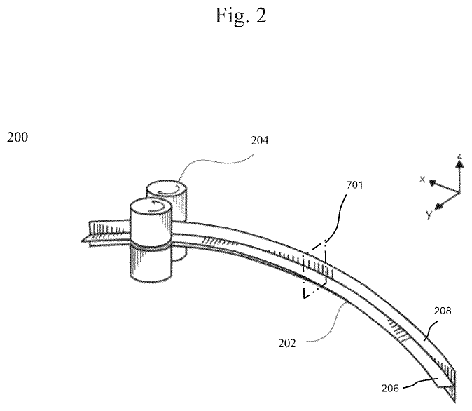

Referring to FIG. 2 a precision feeding system 200 may be shown and described. The feeding system 200 may have a 1st degree of freedom (for example a curvilinear length coordinate the tangent to which is along the X-Axis at the operation plane 701), the length coordinate of a curved workpiece 202 may be along its spine, the intersection of the horizontal leg 206 (web) and the vertical leg 208 (flange) of the extrusion, and the feeding system 200 may be capable of smoothly and continuously feeding the curved workpiece 202. The curved workpiece 202 may be, for example, a curved aluminum extrusion, with an arbitrary form and curvature. The precision feeding system may include one or more parallel sets of friction rollers 204, each consisting of at least a pair of opposed rollers that clamp across a leg of the workpiece and rotate in opposite directions to move the workpiece along its longitudinal direction. Note that the terms feed roller, friction rollers, traction rollers, drive rollers, etc., may be used interchangeably.

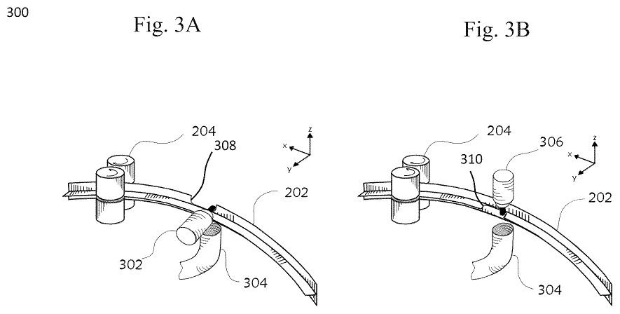

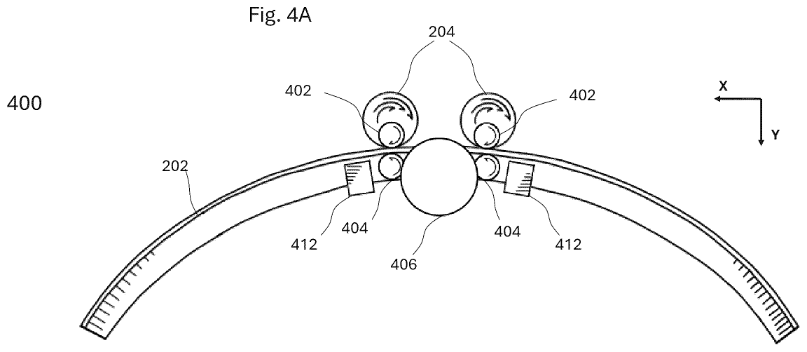

Referring to FIG. 3A-3B, a system for positioning and orienting a tool/spindle at an operating point for the performance of an operation 300 may be shown and described. The system 300 may have a tool and/or spindle 302. The tool and/or spindle 302, may be positioned and oriented using the CNC machine controller in machine coordinates while the workpiece is simultaneously positioned along the curvilinear length axis. The tool and/or spindle 302 may, for example, be a horizontal tool. The tool and/or spindle 302 may perform one or more operations on the workpiece 202, along a segment 308 of an operation path defined along the surfaces of the workpiece.

The system 300 may further include a chip removal system 304 which may ensure that chips produced may be removed from the precision fixturing apparatus. In the example depicted in FIG. 3A, the chip removal system 304, may be a vacuum hose. In other embodiments the chip removal system 304 may instead be, for example, wire brushes or air brushes.

In some embodiments the tool and/or spindle may instead be a vertically oriented spindle 306. In an embodiment the vertically oriented spindle 306 may be positioned and oriented in its machine coordinates and performs an operation on the workpiece 202, along another segment 310 of an operation path.

It may be understood that the configuration shown in FIG. 3A-3B may enable independent operations performance in two different axes, for example parallel to the machine Y axis and Z axis. The operations stations/tools 302 and 306 may be CNC controlled in their local coordinate systems, which may be oriented to the operations performance direction of each spindle. These tools 302 and 306, may be engaged one at a time, in sequence, or in tandem.

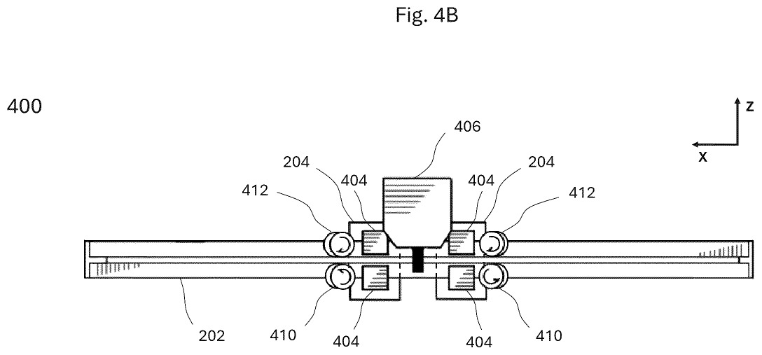

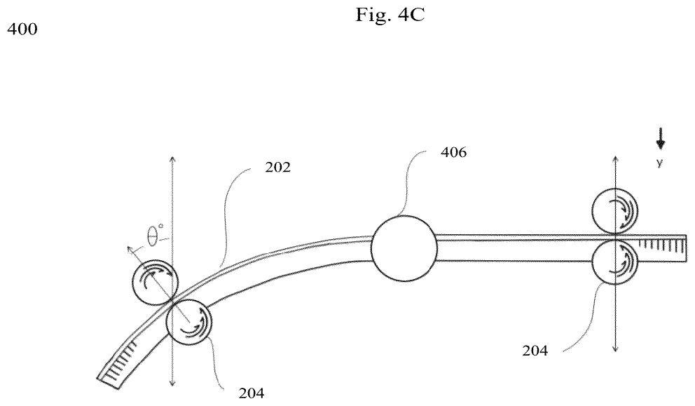

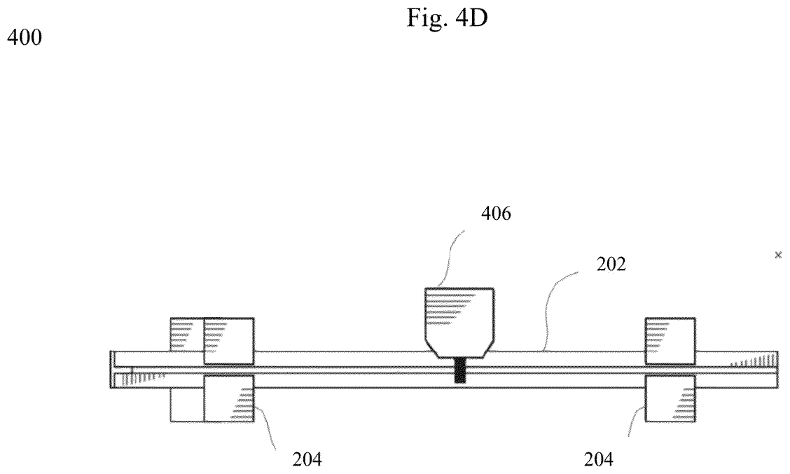

Referring to FIG. 4A-4D, a precision fixturing system 400 may be shown and described. Precision fixturing system 400 may include one or more flange locating rollers 402 located on a locating side of the workpiece. The precision fixturing system 400 may further include one or more rubber coated flange clamping rollers 404 paired with the flange locating rollers, that clamp the flange of the workpiece to the locating rollers. The rubber coated rollers 404 may ensure full contact with the relatively hard rollers 402 and may further provide adequate clamping force between the rollers 402 and 404 as well as between one-sided feed roller 204 and the workpiece required for the feed roller to drive the part by friction. The axis of all these rollers, 204, 402 and 404 may be parallel to machine Z-axis, or may rotate about the A′ axis to clamp perpendicular to the flange when the flange is not at 90 degrees to the web. In either case, the two pairs of flange rollers constrain translation of the workpiece about the Y-axis and rotation about the X- and Z-axes.

Precision fixturing system 400 includes additional web locating rollers 410, which may be located below the web (horizontal leg) of the workpiece. These rollers are free to rotate about their axis, which may be free to swivel in the XY plane but otherwise fixed. The axes of the rollers may be oriented in the XY plane to follow workpieces with different curvatures or may self-align to roll in the direction matching the part movement at those locations, which will result in the least friction. These web locating rollers 410 on the locating side of the workpiece may also be paired with rubber coated web clamping rollers 412 on the clamping side of the workpiece. The two pairs of web rollers constrain translation along the Z-axis as well as rotations about the X- and Y-axes. Even though some roller pairs of one or more of, 402, 404; and 410, 412, may not be required to geometrically locate the workpiece, the configuration shown may increase the rigidity of the location of the workpiece by the UFF. In fact, on account of the fact that machining operations can cause portions of the web and flange to be trimmed, e.g., along segments of operation path 308 and 310, additional redundant locating and clamping roller pairs help hold the part rigidly in cases where some roller pairs of a minimal set of rollers may coincide with such trimmed regions and become ineffective for locating the part.

For precision fixturing system 400 the operation plane, may sometimes be defined as the plane of symmetry of the UFF when the UFF possesses such a plane of symmetry. All operations may take place within this plane, which may be defined as the Y-Z plane of the machine.

Explaining now the operation of FIGS. 4A-4D, the precision fixturing system 400 may feed the workpiece 202, through feed rollers 204, to a predetermined location, lock the workpiece 202 in place, position and orient a tool/spindle at an operating point, and perform operations, e.g. drilling on the workpiece, at predetermined locations, operating points, using both operations stations tools, a horizontal oriented spindle 406 in FIG. 4A and a vertical oriented spindle 414 in FIG. 4B, which may also be called operation stations 406 and 414.

The precision fixturing system 400 may further perform operations, e.g. milling, using operation stations 406 and 414, during which a segment of the workpiece is actively positioned in front of the operation stations 406 and 414, which may be synchronously positioned and oriented to perform the operation over an operation path. The precision fixturing means may act as an active operation that moves the workpiece forwards and backwards along the curvilinear length coordinate. The operations may be used for, e.g., machining pockets and for thinning the workpiece. The unique configuration of the apparatus may enable it to make this precision performance of operations processes possible for relatively flexible, thin, elongate, curved workpieces, such as extrusions and other structural elements.

When performing an operation on a workpiece of constant radius, the cross-section of the workpiece may be perfectly aligned with the operation plane per the described configuration. Alternatively, for a workpiece with variable curvature around the operation point, the operation plane may be slightly adjusted to achieve the required accuracy for performing operations, e.g. machining features. This may be accomplished by adjusting the position and orientation of the operations, e.g. machining, plane with respect to the locating rollers 402. This change in orientation and the offset required to achieve higher accuracy of operations performance, e.g. the machined features, is very small and may be accomplished by adjusting the relative positioning of the roller sets and the precision positioning system.

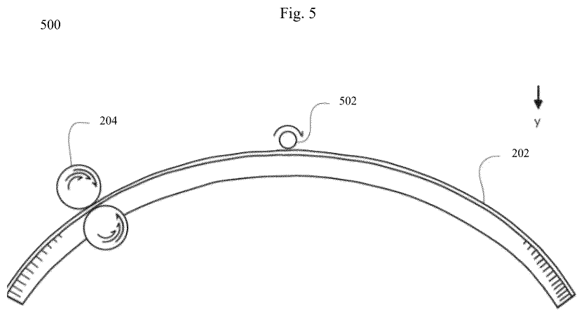

Referring to FIG. 5 a system for feeding the workpiece 500 may be shown and described. The feeding system 500 may include a rotational encoder wheel or equivalent sensor, 502, that measures the workpiece position along the length coordinate by the rotation of a wheel whose rotation is sensed by a rotary encoder, and use this as feedback for closed-loop feedback control of the rotation of the feed roller 204 required to move the workpiece point to the operating point. In some embodiments at least two such encoder wheels or sensors 502 may be provided. These may be identical to, or collocated with, or mounted on one or more of the locating or clamping rollers, 402, 404, 410, and/or 412, or may be mounted elsewhere, and may be used to determine the position of the workpiece 202, with respect to the operation plane. The distance between the encoders 502 and the location at which the operation is performed may be relatively small, both in comparison to the workpiece length and in comparison to the length of the workpiece supported by the precision feeding system 500. Secondary encoder(s), or equivalent sensor(s), may be utilized to ensure accurate positioning of the workpiece 202 and to detect any measurement errors arising from slip between the encoder wheel, encoder wheels rolling over chips, etc.

In some embodiments one or more feeders for the precision feeding system 500 may be installed outside the positioning roller system. In some embodiments the workpiece feeding system 500 may also be provided with one or more supporting end effectors. The supporting end effectors may be CNC controlled in their local coordinate system. The supporting end effectors may give additional support to the workpiece on the opposite face from the operations performance location, operating point, on the workpiece.

The operations performed by the system may include, but are not limited to, inspecting, cutting, targeting, drilling, trimming, milling, thinning, etc., as well as end milling and also peripheral milling. Depending on the desired operations process, a supporting end effector may be provided which may be chosen to provide the best support in the direction that the highest accuracy is required. For example, for peripheral milling, the support in the direction of machining is more important. In such a configuration, the horizontal operations spindle tool 406 may feed into the material in the Z direction, while the end effector may support the workpiece in the opposite face in the Z direction.

The position of the workpiece 202 may be reset using one or more locating features. for example, the defined datum feature(s), which may be, for example, a hole at a known location along the workpiece. The position of the workpiece may also be reset to the datum if significant sliding is detected, e.g., from the difference between the actual and expected readings of multiple encoders, during the performance of the operation(s) on the workpiece. Locating features and/or datum holes may also be defined outside the workpiece to create datum features for cutting the workpiece to size after the performance of the operation(s).

Some embodiments of apparatus 100 may be furnished with additional support opposite the operation point. In addition, embodiments of the apparatus 100 may also include rollers which may be used to force the workpiece into its ideal configuration for more precise and accurate performance of operations, or the apparatus 100 may be additionally provided with rollers which are used to adjust the position of the workpiece, for the performance of operations, in response to calculated deflections and induced variations in the workpiece and in the apparatus 100.

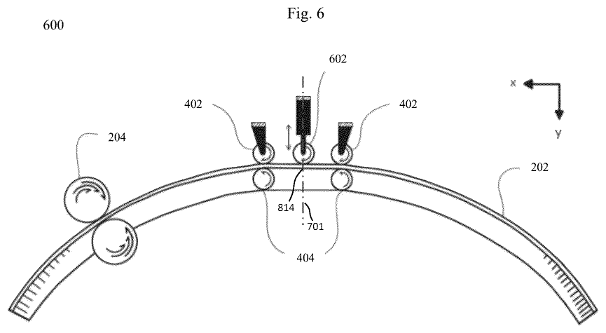

Referring to FIG. 6, an exemplary embodiment of the apparatus providing increased precision 600 and accuracy may be shown and described. The apparatus 600 may use CNC control of the position of roller 602 along the operation plane 701 to modify the local curvature of workpiece 202. Rollers, 402, 404, and 602, may act in concert to force a portion, or all of, the workpiece into a predetermined curvature and the operation may be performed. Roller 602 also provides additional support opposite the operation point 814.

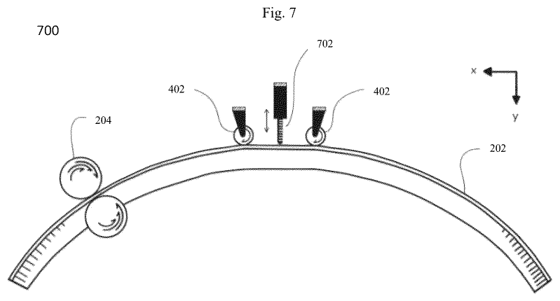

Referring to FIG. 7 another exemplary embodiment of the apparatus 700 may be shown and described. The apparatus may use its CNC capabilities to calculate the deflections and induced variations in both the apparatus and in the workpiece 202. The apparatus may additionally use CNC capabilities, along with a sensor 702, to measure and compensate for these deflections and induced variations. The one or more roller 402 may then adjust the position of the workpiece as the machine simultaneously adjusts the position and orientation of the tool and/or spindle. After the adjustments in position and orientation are made to the workpiece, and the tool/spindle, one or more operations may be performed on the workpiece.

Additionally, one or more supporting end effectors may be provided. The apparatus 700 may also utilize a stiffness calibration procedure enabling it to perform precision operations, e.g. machining. Since the operations performance head and a supporting end effector may both be mounted on control axes, it may be understood they are not fixed in space. The operations performance forces may result in deflection of the system, which may be significant during an operation, particularly for, for example, a milling operation. To overcome this source of error, the stiffness calibration procedure may be performed for a given set of tools and a supporting end effector before an operations process is performed by the given set of tools and supporting end effectors. The procedure may measure the stiffness of the system in the local operations, e.g. machining, direction. The stiffness may change nonlinearly, since the entire system affects the stiffness in that direction. The calibration may increase the motor torque that moves the operations performance axis, pushing it against the supporting end effector. Then the calibration may use the resulting displacement in the operations performance axis and the opposing supporting axis to determine the displacement at the operations performance location. The nonlinear stiffness curve may be actively used to compensate for stiffness of the machine during the operations performance process.

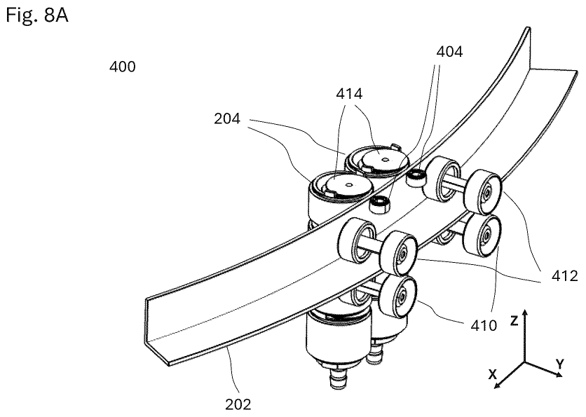

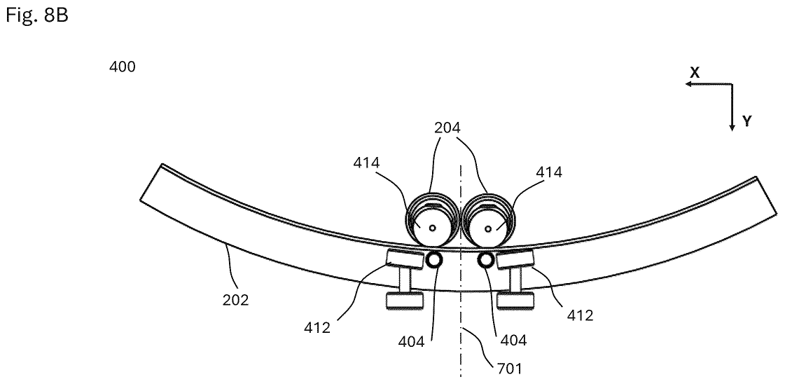

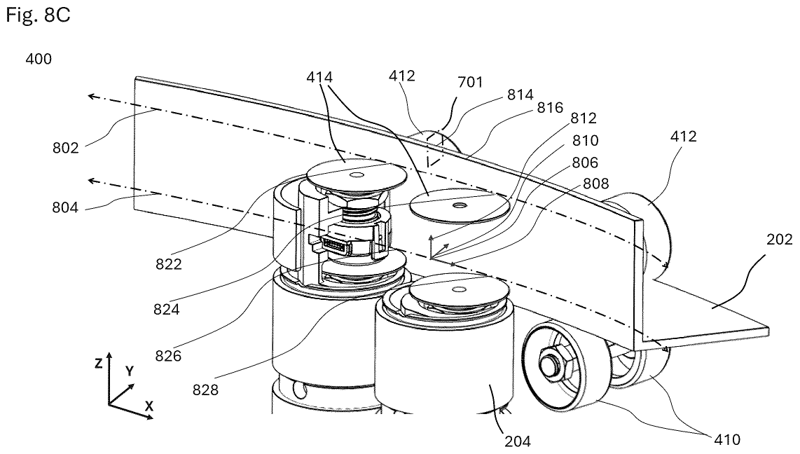

Referring to FIG. 8A-8C, an embodiment of the precision fixturing system 400 is shown and described. The figures show feed rollers 204 with a very thin coating of urethane or other material with high friction coefficient to the workpiece 202 to simultaneously serve as flange locating and feed rollers. Encoder rollers 414 touch the measured curves of the part through slits in the hollow tubular support structure of the feed rollers and provide position feedback for feed rollers 204 to be controlled to feed the part to the desired longitudinal position, i.e. curvilinear length coordinate. Clamping rollers along Y direction 404 keeps the part clamped against the feeding rollers 204, allowing it to be driven, positioned and oriented. Locating rollers, 410, define the part position and establish a datum along the Z-direction for clamping rollers 412 to clamp the part against.

Referring to FIG. 8C, it may be noted that four encoder wheels 414 are touching workpiece 202 along two measuring curves 802 and 804 at measurement points 822, 824, 826 and 828. Each encoder measures the rotary position of the encoder wheel and uses the precisely known circumference of its encoder wheel to infer the position of the corresponding measurement point. Using a kinematic simulation over time of the encoder wheels rolling along the measurement curves, the tracking path for each encoder wheel measuring point over the workpiece can be determined. At any given time, the measured values for the position at the measurement points can be used to estimate the current position of 810, the length coordinate along the longitudinal degree of freedom of the part positioned by the UFF. It may be noted elsewhere that this position 810 may be referred to as O(sₚ)=(sₚ, 0, 0), in a curvilinear coordinate system for the workpiece, or r(sₚ)=(x, y, z) in the workpiece coordinate system. sₚ is the value of the length coordinate along the primary tracking path that needs to be positioned along the operation plane 701 in order for point P, 814, to be positioned along the same operation plane 701. Knowing the machine coordinate directions along the UFF, 808 (X(sₚ)), 810 (Y(sₚ)), and 812 (Z(sₚ)), and the geometry of the workpiece and the tool, the coordinate values of point P along the operation plane, namely (P_{y}, P_{z},), as well as the coordinates of one or more offset points Q=(Qₓ, Q_{y}, Q_{z}) 816, at which new geometry is established by the operation at point 814, can also be determined along the machine coordinate system.

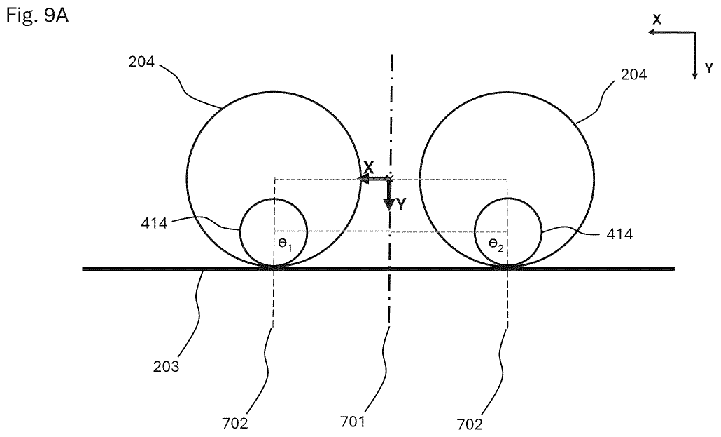

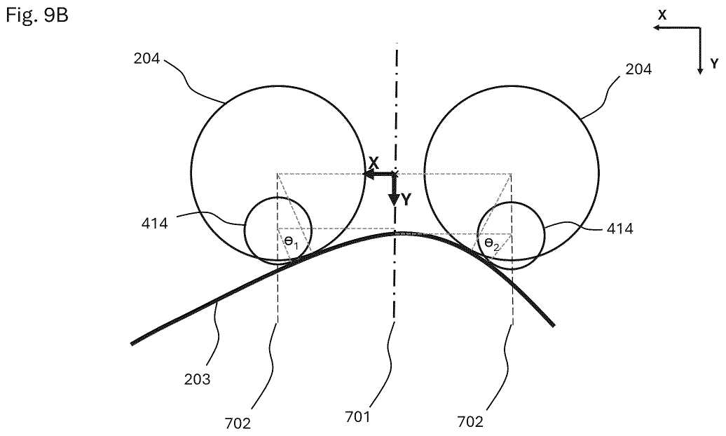

Referring to FIG. 9A-9B, different configurations of the measuring and driving components for straight and variable curvature workpieces are shown and described. Note that the operation plane, 701, is shown along the plane of symmetry of the two feed rollers, 204. The encoder wheels, 414, can move back and forth along encoder moving axes, 702. Note that the point that the drive roller, 204, and the encoder wheel, 414, may touch the workpiece at different points. This is an important aspect that needs to be correctly represented in the kinematic simulation used for calculating the precise position and orientation of the workpiece when traveling over a varying curvature part.

Some embodiments may be especially useful in the case where the workpiece is flexible, i.e., its deflection due to the operation force, gravity, etc., would exceed the tolerance in location at which the operation is to be performed without stabilization by the FF. In some embodiments it may be desirable that the FF be capable of processing a large variety of cross-sections, which may be known as a universal feeding fixture (UFF). Some embodiments may provide for the UFF locating the workpiece surface and clamping onto it across the thickness dimension, at three or more pairs of opposed points to constrain translation perpendicular to the surface and rotation about any axis along the surface. Use of at least two pairs of rollers or omnidirectional wheels as the clamping elements, at least one of which is a driven wheel, may allow for moving and positioning the workpiece and/or the tool in one or two degrees of freedom so that at any given time the operating plane coincides with the cross-section of the workpiece where the operation is to be performed, and the operation point may traverse the required operation path.

Some embodiments may include sensing means for tracking the relative motion between the UFF and the workpiece along one or more tracking paths along the workpiece. For each sensor, the time sequence of corresponding measured points, i.e., the tracking path, of the workpiece may fall along a sweep curve called the measured curve, which may lie along the longitudinal direction of the workpiece. The length of each measured curve that moves past the sensing point in a given time interval may depend on the curvature of the workpiece and the position of the measured curve along the cross-section of the workpiece, in a known, deterministic manner. Workpiece movement along the length curvilinear coordinate may then be measured without conflicts by choosing one of these tracking paths as the primary tracking path, and using a simulation of the workpiece motion through the FF to map the length measured along other tracking paths onto the corresponding length along the primary tracking path, which a sensor measuring along the primary tracking path, at a specific point with respect to the UFF, may read at the same time.

In some embodiments all the sensors and sensing points, supports and supporting points, and clamps and clamping points of the FF may be close to but offset from the processing point so as to not be affected by the processing operation (however it may be understood that in some processing operations it may be beneficial to have one support opposing the tool at the processing point, for example one with a geometry complementary to the processing tool). As such, the position of the workpiece along the primary measurement curve may not have a measurement sensor tracking it but may rather represent the point where the primary measurement curve is intersected by a processing plane (also referred to as operation(s) plane, operating plane, etc.) defined in the machine coordinate system of the operations center. The offset between an instantaneous length coordinate along the primary tracking path and location of the processing point along the length coordinate (which may also be referred to as the curvilinear axis of the machine) may then be determined by a kinematic simulation and be used in the transformation of workpiece processing vectors into machine processing vectors. The processing plane may be a plane transverse to the primary measurement curve. In some embodiments the locating and clamping features of the FF may be arranged symmetrically about this processing plane, e.g., when parts of uniform curvature are located and clamped symmetrically about the processing plane, it may be perpendicular to all planes tangent to the workpiece. Further, in some embodiments it may be desirable that the axis of the tool be constrained to lie along a plane coinciding with the processing plane, in which case the transformation of the workpiece processing vector into the machine processing vector may be approximate when the curvature of the workpiece is not constant along its length.

For accurate machining of flexible parts of imperfect geometry, where the actual geometry (e.g. curvature) of the one or more tracking paths deviate from that defined/required/assumed, with corresponding variation in the length coordinate estimated along the primary tracking path, one or more compensation approaches may be included—for example measuring the actual geometry and compensating for it in the simulation, or using workpiece supports or guides outside of the UFF that enforce the local geometry(tangent, curvature, and torsion) of the region of the part within the UFF, or at least the region around the processing plane, to be equal to the assumed one. In some embodiments a calculation step may use the relative motion sensed along the tracking paths to calculate the position and speed of the operation point along the operation path and may further use the inverse calculation to calculate the movement along the tracking path required to achieve the required motion along the operation path.

The UFF and the tool may be part of a machine that uses the sensed relative motion between the workpiece and the UFF and the known position of the tool in machine coordinates to carry out feedback control of the relative motion of the tool with respect to the workpiece along the length degrees of freedom, while all the other degrees of freedom are constrained, which may minimize the deviation of the operation point from the required operation path. Control of the relative motion may include control of all three positions and all three orientations as well as the speed of movement of the operation point over the workpiece. The relative motion of the workpiece with respect to the UFF, measured by the length curvilinear coordinate positioned along the processing plane may constitute at least one controlled “axis” of machine motion. The machine structure and control system may be designed to be capable of enforcing motion (of the operation point) along the operation path with the stiffness required to resist operation loads (forces and moments) and keep the deviations from the operation path within specified tolerance limits on position and vibration. Where reference is made to an operation point, it may be understood that in reality the point is actually an area that may be approximated as a point or a line in comparison to the other dimensions of the workpiece.

Describing now an exemplary workpiece and coordinate system for the CNC according to one or more embodiments.

A workpiece may be an elongate object, such as an extrusion, that may be curved along its length, the longitudinal curve may be called, for example, a sweep curve, which may be defined on a spine that can be identified and inspected, and have a transverse cross-section that is constant or varies in a known manner along the length. The cross-section swept or lofted along a straight line may be the primary geometry of the workpiece in which a primary processing operation such as extrusion produces the workpiece, the space curve along which the cross-section(s) is swept or lofted imposes a secondary geometry on the workpiece that may be obtained by a secondary processing operation such as stretch forming, and a tertiary geometry may require a series of tertiary processing operations, implementing which in an accurate and economical manner is object of this invention. The workpiece may have a spine, which may be understood to be a portion of the object that is resistant to changes in length and is typically located at the intersection of different legs of the cross-section. The sweep curve may also be the spine, i.e., the curve that the spine of a curved part assumes. The sweep along the longitudinal curve, of geometrical segments describing the outlines/boundaries of the cross-section, may result in surfaces that define the geometry of the boundaries of the workpiece. One or more parts may be produced from a workpiece by the performance of one or more operations along operation paths defined on the surfaces of the workpiece. For this reason, sometimes the words workpiece and part may be interchangeably used.

In general, the spine may be a space curve defined in workpiece coordinates (x, y, z), that could be part of an assembly that a part produced from the workpiece assembles into.

A space curve may be defined by defining the position vectors of each of the points along the curve, such as r(t)=(x(t), y(t), z(t)), wherein t is a free parameter and the functions x, y and z are defined in a manner that uniquely and continuously maps t to points along the curve. Each point may be referred to as r(t), or simply as point t.

In some embodiments the space curve may be defined by a parametric equation where the parameter t is equal to the arc length s measured from an origin point on the curve, so that r(s)=(x(s), y(s), z(s)). Each point can be referred to as r(s), or simply as point s. s, the position of point r(s) along the length of the spine, may in some instances be a function of a time parameter, and may further constitute the value of the first coordinate in a moving curvilinear local coordinate system called the Frenet-Serret frame, that could serve to uniquely identify any point of the workpiece, in a manner that is independent of rigid body transformations of the workpiece within the workpiece coordinate system.

The first derivative of the position vector with respect to the arc length parameter, dr/ds=r′ (s)=(dx(s)/ds, dy(s)/ds, dz(s)/ds)=(x′ (s), y′ (s), z′ (s)), may be the unit vector tangent to the curve at point r(s). The tangent vector is the local direction of change of the curvilinear coordinate s, and may be labeled as the local X-direction of the workpiece coordinate system, where X(s)=r′ (s) is the representation of the vector in the workpiece coordinate system. If the tangent vector is not uniquely defined at a point, the sweep curve may be said to be kinked at that point. Elongate workpieces curved by forming processes typically do not exhibit such kinks because the strain required to cause a straight workpiece of finite cross-section dimensions to kink at a point is infinite, and would cause the workpiece to rupture. Kinks that may be defined in geometric models will be approximated by curving operations as smooth curves.

The second derivative of the position vector of the spine with respect to the arc length parameter at point r(s) is dr′/ds=r″ (s)=(dx′ (s)/ds, dy′ (s)/ds, dz′ (s)/ds)=(x″ (s), y″ (s), z″ (s)), which is the curvature vector K(s) at point s. K(s)=r″ (s)=K(s) n(s) is the representation of the curvature vector in the workpiece coordinate system. This vector may be understood to point from point r(s) towards the position vector of the center of curvature of the spine curve, c(s), which may be located at a distance R(s)(the radius of curvature at point s) from the point r(s) in the normal direction n(s). The magnitude of the curvature vector K(s) may therefore be the curvature, K(s), which may be the reciprocal of the radius of curvature such that (|K(s)|=K(s)=1/R(s)).

The plane containing the tangent vector=r′ (s) and the curvature vector K(s) may be the local (osculating) plane of the curve at point s. A planar sweep curve may be understood to be one for which the local plane of the curve remains the same for all points along the curve.

Sweep curves of real parts formed by metal forming may be smooth in the sense that the first derivative of the curve(the slope) is continuous at all points(there is no kink in the curve), which may be understood to mean that the second derivative(the curvature) is at least piecewise continuous (continuous other than for finite jumps at a finite number of points).

The cross-section at any point P located at (xₚ, yₚ, zₚ) in the workpiece coordinate system may be understood to be the area(the closed figure) that is obtained when the workpiece is sectioned (or cut) by a transverse plane passing through that point, where that area is also perpendicular to the spine (i.e., perpendicular to the tangent vector X(sₚ)=r′ (sₚ) at the intersection point sₚ). Thus, the term “cross-section” used herein refers to a “perpendicular cross-section”.

Conversely, the geometry of the workpiece, i.e., the volume occupied by it, may be obtainable by sweeping or lofting the cross-section along the sweep curve, either with or without variations in cross-section, e.g., a draft angle or taper. The geometry may also be obtained by lofting two or more cross-sections along one or more guide curves. Additional CAD modeling operations may then be done to add volume to or remove volume from the basic determined shape.

In an embodiment where the flexible fixture feeds the workpiece along one degree of freedom, the geometry may be limited to be one where either (i) the spine is a planar curve and the workpiece has enough torsional stiffness about the length axis for the spine to deviate negligibly from that plane when the intended operation is being performed with the tool, or (ii) the geometry of the cross-section has features (e.g. straight edges, lobes, involute profiles, etc.) that remain consistent along the length of the part in order for a segment of the part near the point P to be located or fixtured (i.e. positioned and oriented) deterministically with respect to these features. If the former, any segment of the part may be fixtured by forcing the workpiece to conform to a plane and feeding the workpiece such that point P lies along the operating plane. If the latter, a typical cross-section may contain a feature that can be used to locate the cross-section deterministically. For example, it might have at least one edge that is nearly straight (i.e., whose deviation from straightness is negligible in comparison to its length). The straight line that approximates one edge may be used as the Y-coordinate axis and a unit vector along this direction may be labeled as Y(sₚ). A line perpendicular to the Y-axis drawn through any other identifiable feature of the cross-section (not necessarily along the Y-axis) may constitute the Z-axis and the unit vector along the Z-axis may be represented as Z(sₚ). The intersection of the Y- and Z-axes may constitute the spine, and therefore be the local origin O(sₚ)=(sₚ, 0, 0) of the curvilinear workpiece coordinate system at that cross-section. The origin may or may not coincide with the intersection of the spine and the cross-section plane through point P(i.e. the location of r(sₚ) along the cross-section plane). If a lobular feature of the cross-section were to be used for fixturing the workpiece, Y(sₚ), Z(sₚ), and O(sₚ) may be uniquely determined with respect to the feature using any chosen method, for example by orienting Z(sₚ) along the axis of symmetry of the lobe, and locating O(sₚ) to coincide with the apex of the lobe.

The Y- and Z-coordinates of point P(x, y, z) on the cross-section may be measured by the distances from the origin to the perpendicular projections of that point on to the Y- and Z-axes, Y(P) and Z(P), respectively. The coordinates (sₚ, Y(P), Z(P)) may constitute an alternate definition of point P(x, y, z) of the workpiece in the curvilinear (Frenet-Serret) workpiece coordinate system. For planar parts, the Y and Z coordinates (Y(P), Z(P)) may have an offset(that depends on the curvature) with the Y and Z machine coordinates of point P, and for other parts a suitable transformation may be needed to obtain the machine coordinates.

It may be understood that there may be some sections missing the edge that defines the Y-coordinate direction, for which this direction may then be defined by filling in any material that was removed from the swept volume, or by interpolating or extrapolating the Y-coordinate directions of neighboring cross-sections (Y(sₚ₊) and/or Y(sₚ₋)) that do contain this edge along r(sₚ). In a similar manner, the location of the Z-coordinate direction (and thus the origin) may be interpolated or extrapolated from neighboring sections in case the feature defining the location of the Z-axis (and thus the local origin) is missing in any given section.

Given a need to locate a tool at point P(sₚ, Y(P), Z(P)), this may be done by having the curvilinear length coordinate positioned at the point r(sₚ) expected based on the geometric definition of the workpiece in relation to the machine coordinate system and then by positioning the tool at (Y(P), Z(P)), plus any offsets, along the operation plane. Additionally, to position point P at the operation plane, the measured point along the primary tracking path may need to be positioned at r(sₜ). However, due to real-world issues such as variation in actual geometry of the workpiece from the defined geometry, flexibility of the workpiece, etc., in the prior art a fixturing tool that is produced more accurately than the workpiece may be required. The fixturing tool may also be much stiffer than the workpiece, have locating surfaces that match extensive regions of the exterior surface of the workpiece, and/or have elaborate clamping arrangements to force the workpiece to conform to the fixturing tool over these extensive locating surfaces, to make the workpiece lie in a configuration close enough to the defined configuration for the tool to be positioned at point P with sufficient accuracy.

Therefore, in some embodiments it may be advantageous from the perspective of cost, accuracy of location, ease of implementation, etc., if, for positioning any point P, the corresponding point O(sₚ) is correctly positioned with respect to the machine coordinate system, and the corresponding directions X(sₚ), Y(sₚ), and Z(sₚ), are oriented in the required manner. This may be accomplished via the positioning and locating elements of the FF method. Assuming that the fixturing elements act on the workpiece surfaces at i cross-section plane r(sᵢ), to control one or more of X(sᵢ), Y(sᵢ), Z(sᵢ), and O(sᵢ), a suitable choice of the i locations and of the fixturing elements may constrain the workpiece segment to be rigidly positioned and oriented such that point P lies along the operating plane, and at the required coordinate locations along the operation plane. Since the configuration of the fixturing elements are known (i.e., their relative positions and/or orientations and the constraint directions they impose are known with respect to the machine coordinates and the operating plane), knowing the length coordinate of the workpiece along any tracking path, for instance Sti, the extents of the workpiece segment within the UFF may be known in the machine coordinates.

Explaining now the use of swiveling rollers as supports. In some embodiments one or more swiveling rollers may be used as supports. In an exemplary work center one or more self-aligning bearings may be utilized where the axis of rotation of a shaft supported by the bearing may be non-parallel to the axis of the housing supporting the bearing. In some embodiments the self-aligning bearing may be a wheel which may help move a carriage over a surface to allow the motion vector of the carriage to have a non-zero component along the axis of the wheel in additional to motion predominantly along the direction perpendicular to the normal projection of the axis on to the surface. It may be understood that in an embodiment the supports may have to be as close to the operation point as possible in order to reduce the deflection of the workpiece in response to the component of operation force reacted by the supports. It may be understood that in the embodiment the workpiece may act as a beam and deflect in between the supports, where the deflection grows as the third power of distance between the supports.

In an embodiment, to minimize the unsupported length while allowing free access to the workpiece (for the tool) along the operating plane, it may be desirable to use very small bearings as supporting wheels/rollers. In some further embodiments a swivel tip setscrew may be utilized as the axle with the center of rotation of the swivel tip located at the midplane of the inner raceway of a normal bearing (which are also available in smaller sizes than self-aligning bearings), so that even very small bearings may be used as supports, without exerting axial forces when the direction of movement of the workpiece has a component along the axis of the support.

Now describing how feeding may be performed by drive rollers close to the operating point and the supports in some embodiments.

In some embodiments one or more drive rollers or drive wheels or friction wheels may be required for applying a feeding force for feeding the workpiece along the operation path against the friction forces at the supports, operation force, inertial force, etc. It may be understood that in some embodiments the supports may react to forces perpendicular to the longitudinal direction and the feeding force may react to forces in longitudinal direction. In an embodiment where the applied feeding force is situated remotely from the force to be reacted, the workpiece may act as a curved beam subject to axial forces, and it may be understood the deflection increases as the third power of the distance. Therefore, in some embodiments, the distance may be minimized by using one or more of the closest support wheels on either side of the operation plane as driven rollers or wheels.

In an embodiment, to allow access to the workpiece along the operation plane, it may be understood that the feeding force as well as the minimum distance may be limited by the radius of the drive roller. Large feed forces may be supported using small feed rollers coated with high friction materials such as, for example, urethane, electroplated diamond, etc., and the driving torque may be provided by drive shafts with universal couplings, friction drives, belt drives, etc. In some embodiments the use of friction drives or belts may allow for the drive rollers or wheels to be hollow, and a small read head or encoder wheel may be positioned inside of the hollow drive rollers or wheels. The read head may measure the position along a linear scale affixed to the surface of the workpiece that is driven by the drive rollers, to lie in an axial gap between the outer sleeves of two drive rollers. In this case the linear scale becomes a measurement curve. The encoder wheel may touch the corresponding measurement curve on the workpiece through slits in the inner shaft of the drive roller or wheel, while the outer sleeve of the drive roller may be driven by a secondary drive pulley that supports and drives it by friction along a contact line, which may be diametrically opposed to the line of contact of the drive roller with the workpiece. In some embodiments the friction drives may also be backlash free, and lost motion may be minimized by using rigid wheels or rollers with high friction surfaces. In some embodiments double U-joint spline drivers may further be used to accommodate changes in length and angle without fluctuation in output speed.

Now describing measuring relative motion along the curvilinear axis using multiple thin encoder wheels through slits in the drive roller in some embodiments.

When a curved workpiece moves relative to a machine, the typical movement may be understood to be combined rotation and translation. The rotation may cause different fibers (each being the curve formed by a point of the cross-section swept by the sweep curve) along the workpiece to travel at different speeds. If a thick disc is used as an encoder wheel to track the movement of a curved workpiece, the tracking path may change from one curve on the workpiece surface to another, randomly from time to time. The result is that it may be unclear which curve is really tracked. This may cause uncertainty in the length coordinate which is positioned along the operation plane of the machine.

In an embodiment, thin discs may be used as encoder wheels so that the tracking path on the workpiece is known to within the thickness of the disc, which may be chosen so that the position is known accurately to within a specified tolerance. The ideal encoder wheel according to an exemplary embodiment may be shaped like a thin disc cut from a spherical ball of matching radius, with the equator being the axial plane of symmetry of the disc. The minimum thickness of the wheel may be such that its deflection as well as marking of the workpiece surface due to contact force applied for tracking is negligible. The ideal material for the encoder wheel may be, for example, a composite having low elastic modulus that also has high friction to the workpiece surface.

Since uncertainty in the curvature of the workpiece and workpiece deflection may cause increasing uncertainty in the longitudinal location of the workpiece as the distance of the measuring point increases from the operation plane, it may be desirable in some embodiments to measure the position along the tracked path as close as possible to the operating plane, including at the same length coordinate as one or more of the drive rollers. The position may therefore be tracked by simulating changes in the tangency point of the thin encoder disc as a function of the geometry of the curve segment between the tangency points corresponding to each of the drive rollers.

The thin disc narrow encoder wheels may contact the workpiece through slits in the drive rollers while the encoder itself may be physically located above or below the drive rollers. In some embodiments the entire encoder may even be located within the drive roller, which may allow multiple encoders and their wheels to be situated inside hollow inner shafts of the drive rollers. The encoders may track the movement of the workpiece at one or more discrete contact locations along one or more tracking paths on the workpiece. A known geometry of the curved workpiece may be used to calculate from the measurements of each individual encoder along its corresponding tracking path an estimated equivalent length coordinate along its curvilinear axis (i.e., the location of the workpiece in the longitudinal direction, defined by the primary tracking path). This calculation step may convert the measured motion along the tracking path into the measured longitudinal position of the workpiece, while also accounting for the different speeds of motion of the curved workpiece along the different tracking paths.

Measurements from multiple sensors may be combined via, for example, a Kalman filtering algorithm to fuse the measurements with the expected position based on process physics and arrive at the best estimate of the workpiece position, or a clustering algorithm to identify and eliminate outliers that are producing inaccurate readings, etc. The clustering algorithm may compare the incremental equivalent length readings from the multiple sensors to identify at any given time the encoder wheels that are reading most accurately. Therefore, the algorithm may detect when the encoder wheels may transiently be slipping due to the wheels losing contact with the workpiece or rolling over chips, etc. This may be particularly important when excessive vibrations are imposed upon the workpiece by the operation. These sensor fusion techniques may also allow the use of different sensors, including, for example, non-contact sensors that measure the motion of a surface along one or more dimensions by digital image correlation, laser speckle interferometry, laser doppler velocimetry, etc.

Now describing compensating for deviation of the actual curvature of the workpiece from the defined geometry in some embodiments.

The actual geometry of curved workpieces may deviate from the defined geometry, to different extents depending on the level of perfection of the workpiece. This may occur due to, for example, deviations in the free state and due to forces imposed on the workpiece, especially as it may be understood that elongate curved workpieces may be especially flexible. This deviation of geometry may cause both the tracking paths and the operation paths to be different from those assumed based on the definition of the ideal geometry. In some embodiments this deviation may be accounted for by measuring the actual curvature of the part within the operation zone by using a distance measuring sensor to measure the part close to the operation plane (in the unsupported length between the supports), and calculating the new operation path on which the operation has to be done in order for the part to be close to the ideal geometry when the curvature of the part is forced to conform to the actual definition in a later step. The calculation step may be done using, for example but not limited to, simple analytical models, or more detailed ones such as finite element models.

In other embodiments, part supports may be used outside of the UFF to bend the workpiece so that its curvature matches the defined geometry(tangent, curvature, and torsion) within the UFF, which may ensure that the previously calculated relationship between the tracking path(s) and the curvilinear axis of the machine, as well as the relation between the position along the curvilinear axis and the operation path hold true.

Describing now calculating the tracking path (motion along the curvilinear length axis) for enforcing the required motion of the tool along the operation path in some embodiments.

It may be understood that the following description focuses on an exemplary embodiment where the workpiece is constrained by the roller supports and clamping forces so that the drive rollers can position the part along a single degree of freedom perpendicular to the lines of contact at the rollers. It may be appreciated that other embodiments, for example where the workpiece is a curved sheet and omnidirectional wheels are used to position it in two degrees of freedom, may be extensions of this case.

It may be understood when reference is made to a point of the workpiece, it refers to a specific material point of the workpiece, identified by its location in the workpiece coordinate system in which the workpiece geometry is defined. In an embodiment any given point of the workpiece may occupy different spatial locations in a cartesian coordinate system attached to the machine when the workpiece and/or the machine move relative to one another.

To locate operation point P of the workpiece at an operating plane of the machine for the purpose of carrying out the operation, the flexible fixture (FF) method may fixture a workpiece of known geometry so that its geometry close to the operation plane (within a operation zone) is determined with respect to the machine. This may be done by using supports of known geometry at known positions and orientations in the machine coordinates to constrain features on a region of the part within the UFF. Positioning of the operation point may be accomplished by positioning tracking point P′ (near P, for example, along primary tracking path ru (su)), at a calculated point in the machine coordinate system at the required time corresponding to length coordinate sₜ. In some embodiments it may be preferable to select measurement curves near the stiffest portions of the workpiece(that are near the neutral axis of the workpiece and deflect the least in response to forces). Such a curve may also be called a spine when it is located at the intersection of two surfaces so as to be visually identifiable. In an embodiment, the only degree of freedom available at P′ for the segment to move may be the curvilinear length coordinate along the tracking path, i.e., along the tangent to the tracking curve at P′, which may be a known direction. Two translations in the plane perpendicular to the tracking curve and all three orientations (roll, pitch, and yaw) of the perpendicular cross-section through point P′ may be constrained by the supports. Given the known geometry of the part, and the known position, orientation, and geometry of the supports, changes in the three orientations of the work piece may be calculated and factored into account to calculate the movement of the point P as the part is fed along the tracking curve at P′. Using this process, the part may be fed the appropriate distance required to position point P along the operating plane. The position of point P along the operating plane, and the orientation of the workpiece at this point may also be known. The workpiece may then be held in a deterministic manner within the operation zone of the FF for the intended operation to be performed at point P.

The advantages of the UFF process may be understood to include, for example, avoiding part specific fixtures; being able to process the entire surface of parts without the need to reposition fixturing elements; capability to deterministically and stiffly hold flexible parts that are curved or straight; reduced number of supports (locators) and clamps required to fixture the part; fixturing a part near the operating point but not right at or opposite the operating point so that the part stiffness is sufficient for it to be held rigidly for even high force operations such as thinning; enabling a machine to perform operations on parts that are much longer than the machine extents; processing parts of complex geometry using simple machines as compared to much more complex machines; using the locating features of the workpiece itself as a reference so that deviations of the curvature of the spine from the defined curvature have negligible affect on the accuracy of location of operating points near the cross-section containing the locating features; capability for forcing the workpiece into a predetermined curvature and configuration within the FF; means for determining and compensating for workpiece deviations from the required/ideal geometry, etc.

Describing now the steps comprising the UFF method of locating point P at a known position along the operating plane in an embodiment according to an embodiment.

Given a point P, which needs to be positioned to lie in the operating plane, the UFF method may begin by determining sₚ, r(sₚ), X(sₚ), Y(sₚ), Z(sₚ), O(sₚ), Y(P) and Z(P)) using the steps described above. Then using the known configuration of the fixturing elements that position and orient the known segment of the part near point P, Sₜ₁ and the point rₜ₁ (sₜ) may be calculated in order to position the point along the spine whose length coordinate is sₚ at its required position r(sₚ).

Measurements may be done by, for example, a length measuring device, such as an encoder wheel in contact with the spine of the workpiece or any other longitudinal curve substantially parallel to the sweep curve. The rotating encoder wheel may also serve as one of the locating features, provided that the other locating and clamping features effectively fix all the five DOFS.

In an embodiment where the workpiece is gently curved, for which the radius of curvature of the sweep curve is large in comparison to the cross-section extents, the local (curvilinear) X-coordinate of any point of the workpiece that is contained within the extents of the workpiece may be understood to be unique. If the radius of curvature were small in relation to the extents of the cross-section, perpendicular cross-sections at multiple X-coordinates may contain a given point on the workpiece, in which case the arc length coordinates that would position the operating point as required by an operation path can be found by simulation of the kinematics of the workpiece being positioned by the UFF.

Given the gently curved nature of the workpiece, each segment of the sweep curve (at any X-coordinate), whose extent along the length is a few times that of the extents of the cross-section of the workpiece, may be considered to lie approximately along a plane containing the tangent and curvature vectors. This plane may be, for example, the local plane of the spine and the Y-axis, Y(sₚ).

Furthermore, the workpiece may be envisioned to have a “thin cross-section”, which may allow the spine of the segment to be forced by “planarizing forces” to elastically lie on a plane when constrained by the UFF, and to springback to its pre-existing geometry upon removal of the conforming forces.

For cross-sections containing multiple straight edges that could be used to define the Y-direction, if an edge lies close to the local plane of the spine over most of the part, that edge may be chosen to define the Y-coordinate direction, and the X-Y plane may be close to the local plane of the spine.

To obtain the machine coordinates (sₚ, Yₚ, Zₚ) of any point of the workpiece P(xₚ, yₚ, zₚ) in the workpiece coordinate system, the operation plane that passes through the point may be drawn and its intersection with the spine used to locate the length coordinate along the spine (i.e., the sₚ coordinate value). The Y and Z coordinate directions may then be identified as a pair of two orthogonal directions(the basis) for this plane, and perpendicular projections of the point onto these directions may be used to obtain the Yₚ and Zₚ coordinates, respectively. This is more exact compared to using the cross-section plane to obtain an approximate estimate as suggested elsewhere.

The stiffness calibration process may utilize a stabilizing algorithm to ensure smooth compensation for stiffness changes. The stabilizing algorithm may take the effect of operations performance loads into account. This may vary, for example, in machining operations as the depth of cut in the machining process changes due to a change in resultant loads that can pull the tool in for specific tools and machining rates.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for performing an operation on a workpiece comprising:
holding the workpiece in a feeding fixture so that the workpiece is movable in one degree of freedom along a length of the workpiece and constrained in all other degrees of freedom;
feeding the workpiece along the workpiece's length into an operations center;
measuring the position of the workpiece in a length direction with respect to the feeding fixture using one or more sensors, the measurement being a cumulative distance the workpiece has moved past a known point on the feeding fixture, with a zero position being defined as the position of the workpiece when a known feature is at a known position with respect to the fixture or the operations center;
calculating the orientation of the workpiece with respect to the feeding fixture as a function of the workpiece position;
transforming a time sequence of processing vectors on the workpiece that are defined in a workpiece coordinate system into a calculated time sequence of processing vectors in a machine coordinate system;
using a machine control system to move a processing end effector through the calculated time sequence of processing vectors in the machine coordinate system; and
performing one or more processing operations on the workpiece;
wherein during the one or more processing operations the workpiece moves back and forth relative to one or more rigid elements whose position and speed are controlled, and the position and speed of the workpiece is controlled as a function of time.

2. The method of claim 1, wherein the workpiece is a curved elongate workpiece, and elements of the feeding fixture are positioned to match a curvature of the workpiece in order to accommodate changes in the part configuration transverse to the length.

3. The method of claim 2, wherein the operation is performed on the workpiece by keeping the location of one or more processing vectors in close proximity to a plurality of contact points of the feeding fixture so that the deflection of the workpiece due to processing forces and moments is less than a deflection tolerance.

4. The method of claim 3, wherein backlash free machine elements and preloaded bearings are used to increase the stiffness of the means by which the workpiece is held as well as fed through the feeding fixture.

5. The method of claim 3, wherein the workpiece has a sweep curve; and
the method further comprising using one or more positioning end effectors to force the workpiece so that the sweep curve of the workpiece is deformed into a predetermined geometry at a processing vector when the one or more operations are performed.

6. The method of claim 1, wherein the feeding fixture includes one or more traction rollers, each of the one or more traction rollers further including a surface that has high coefficient of friction to the workpiece surface.

7. The method of claim 2, wherein the sensors include one or more encoder wheels rolling along the length of the workpiece to measure its position along the length, said wheels situated inside the one or more traction rollers and making contact with the workpiece through slits along the circumference of the traction rollers.

8. The method of claim 7, further comprising calculating the workpiece position by utilizing a sensor fusion algorithm to account for imperfect measurements; and
using the calculated workpiece position as the position of a machine axis controlled by the machine controller.

9. The method of claim 3, wherein one support of the feeding fixture on a side of the workpiece opposite a tool supports the workpiece against the force of the processing operation.

10. The method of claim 9, wherein the workpiece has a sweep curve;
the method further comprising using one or more positioning end effectors to force the workpiece so that the sweep curve of the workpiece is deformed into a predetermined geometry at a processing vector when the one or more operations are performed; and
a support against the force due to the processing operation is dynamically positioned so that the sweep curve of the workpiece is deformed into a predetermined geometry.

11. The method of claim 10, wherein the curved elongate workpiece is flexible;
wherein the deflection of the part due to processing forces is reduced by keeping the processing point of the workpiece in between a plurality of contact points of the feeding fixture.

12. A system for performing an operation on a workpiece comprising:
an operations center;
a feeding fixture configured to hold the workpiece so that the workpiece is movable in one degree of freedom along a length of the workpiece and constrained in all other degrees of freedom;
one or more sensors that measure the position of the workpiece in a length direction along measured curves on the workpiece, the workpiece position being a cumulative distance the workpiece has moved along a primary measured curve past a known point and a zero position being defined as the position of the workpiece when a known feature is at a known position;
a motion control system which feeds the workpiece to achieve a required time sequence of workpiece positions and causes a synchronized movement of a processing tool through a calculated time sequence of processing vectors in a machine coordinate system;
wherein feeding of the workpiece includes back and forth motion relative to one or more rigid elements whose position and speed are controlled by the operations center;
wherein the operations center calculates the orientation of the workpiece with respect to the feeding fixture as a function of a workpiece position and transforms the required time sequence of processing vectors on the workpiece that are defined in a workpiece coordinate system into the calculated time sequence of processing vectors in a machine coordinate system; and
wherein the operations center performs one or more operations on the workpiece at the processing vectors.

13. The system of claim 12, wherein the workpiece is a curved elongate workpiece.

14. The system of claim 12, wherein the feeding fixture includes at least backlash free drives and preloaded bearings to hold the workpiece stiffly along the constrained directions and feed the workpiece stiffly along the length direction.

15. The system of claim 14, wherein the operation is performed on the workpiece by keeping the location of one or more processing points in close proximity to a plurality of contact points of the feeding fixture so that the deflection of the workpiece due to processing forces and moments is less than a deflection tolerance.

16. The system of claim 15, wherein the workpiece has a sweep curve; and
force is applied, by the operations center, to the workpiece outside of the feeding fixture so that the sweep curve of the workpiece is deformed into a predetermined geometry around an area where the one or more operations are performed.

17. The system of claim 12, wherein the feeding fixture includes one or more traction rollers, each of the one or more traction rollers further including a layer of urethane.

18. The system of claim 12, wherein the feeding fixture is a universal feeding fixture that includes one or more encoder wheels situated in slits in each of one or more traction rollers.

19. The system of claim 18, wherein the machine controller utilizes a slip detection algorithm to derive a virtual axis for the workpiece.

20. The system of claim 12, further comprising a machine end effector which performs the one or more operations on the workpiece; and
a coupling which connects the machine end effector to the feeding fixture;
wherein the machine end effector interfaces with the feeding fixture such that the forces and moments exerted by the tool on the part flow directly from the part to the feeding fixture, to a coupling, and back to the machine end effector.

21. The system of claim 12, wherein the operations center is the volume of operation of a robot;
the one or more operations performed by the operation center is a simple workpiece handling task;
the feeding fixture becomes the end effector of the workpiece; and
wherein the method further comprises the robot threading the workpiece in until the robot is holding the workpiece close to a center of gravity of the workpiece; and
the robot places the workpiece in a different location with a same or different orientation.

22. The system of claim 20, wherein the feeding fixture possesses a plane of mirror symmetry along which the axis of a tool lies; and
the distance between the two mirror-symmetric halves of the feeding fixture is adjustable in order to manipulate flexible parts of the workpiece with lesser deflection.

23. A method for performing an operation on an elongate curved workpiece comprising:
decomposing a geometry of the workpiece defined in a workpiece coordinate system into
a primary geometry including a cross-section of the part that is swept along a spine of the part,
a secondary geometry including deformations of the cross-section geometry superimposed on the primary geometry as a function of the length along the spine, and
a tertiary geometry including processing vectors at which one or more defined processing operations are to be performed;
creating a length coordinate which is equal to an arc length of a curve of the workpiece along the spine of the workpiece;
supporting and clamping a segment of the workpiece beginning at a defined position along a length of the workpiece using a feeding fixture so that the workpiece is fully constrained in six degrees of freedom in a known position and orientation with respect to an operations center;
moving the workpiece along the length coordinate by the feeding fixture while constraining the other five degrees of freedom of the workpiece;
measuring distance along the length coordinate by measuring the movement of the spine of the workpiece past a measuring point on the feeding fixture;
setting the origin for the length coordinate to be when a particular feature of the work piece coincides with a particular locating point of the feeding fixture;
feeding the workpiece along the length coordinate until a predetermined length of the workpiece is positioned at the measuring point;
determining the tertiary geometry of the segment held within the feeding fixture based on the length coordinate and the overall geometry of the workpiece;
transforming the tertiary geometry of the workpiece to a calculated time sequence of processing vectors in the machine coordinate system based on the known position and orientation at which the segment is held with respect to the structure of the operations center by the feeding fixture;
positioning and orienting the tip of a tool held in an end effector of the operations center along the time sequence of calculated processing vectors in the machine coordinate and performing one or more operations on the workpiece by the operations center.
